(19) United States
(12) Patent Application Publication
(10) Pub. No.: US 2017/0064928 A1
(43) Pub. Date: Mar. 9, 2017

(54) CANINE HANDLING APPARATUS

(71) Applicant: Jo Won Seuk, Highland Falls, NY (US)

(72) Inventor: Jo Won Seuk, Highland Falls, NY (US)

(21) Appl. No.: 14/604,369

(22) Filed: Jan. 23, 2015

Related U.S. Application Data
(60) Provisional application No. 61/934,166, filed on Jan. 31, 2014.

(51) Int. Cl. A01K 27/00; A41F 9/00

(52) U.S. Cl. CPC A01K 27/003; A01K 27/001; A01K 27/005; A41F 9/002

(57) ABSTRACT

A canine handling apparatus for tethering a dog to a handler so that the handler maintains use of both hands while maintaining positive control of the dog. The handling apparatus includes in combination a collar, a handler sling and a lead, which are detachably connected together by a pair of carabiners. The collar, sling and leads are made from nylon webbing and use quick connect buckles and adjustment slides. The collar includes two opposed tag loops of braid cord or cable and a D-ring, which are oriented along the length of collar to be 180 degrees directly opposite one another. The sling has an integrated pouch for stowing small items, such as small bags for collecting dog feces.

This application claims the benefit of U.S. Provisional Application No. 61/934,166 filed Jan. 31, 2014, the disclosure of which is hereby incorporated by reference.

This invention relates to an apparatus for handling canines, and in particular a combination of a collar, sling and lead.

### BACKGROUND AND SUMMARY OF THE INVENTION

Canines (dogs) are used by military and law enforcement to perform a variety of duties. Canine handlers guide and control their dogs using hand held leads (leases) connected to the dog's collar. The handler physically grasps and hold the lead to maintain control of the dog. In many situations, a handler needs to use both hands to manipulate one or more pieces of duty equipment while still maintaining positive control of his dog. In such situation, the handler must tie the lead to a fixture or himself in order to free both hands.

The present invention seeks to provide a canine handling apparatus for tethering a dog to a handler so that the handler maintains use of both hands while maintaining positive control of the dog. The handling apparatus consists in combination of a collar, a handler sling and a lead, which are detachably connected together by a pair of carabiners. The collar, sling and lead are made from nylon webbing and use quick connect buckles and adjustment slides. The collar includes two opposed tag loops of braid cord or cable and a D-ring, which are oriented along the length of the collar to be 180 degrees directly opposite one another. The sling has an integrated pouch for stowing small items, such as small bags for collecting dog feces.

The lead has opposed looped ends and two additional hand loops spaced along its length. The sling can be used in conjunction with the collar and lead to allow the dog to be tethered to the handler so that the handler retains free use of both hands while maintaining positive control of the dog. Typically, the sling is worn around the torso over one shoulder, but may also be worn around the waist. The lead and collar can also be used without connection to the sling. The lead has three looped hand hold position formed by the proximal end loop and the two hand loops, which allows the handler to handle the dog at different distances and levels of control.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a perspective view of an embodiment of the canine collar used in the canine handling apparatus of this invention in an unbuckled position;

FIG. 2 is a perspective view of the canine collar of FIG. 1 in a buckled position;

FIG. 3 is a perspective view of an embodiment of a handler sling used in the canine handling apparatus of this invention;

FIG. 4 is a perspective view of an embodiment of a canine lead used in the canine handling apparatus of this invention;

FIG. 5 is a perspective view of a canine handler using the canine handling apparatus including the canine collar of FIG. 1, the handler sling of FIG. 3 and the canine lead of FIG. 4 to control a dog;

FIG. 6 is a perspective view of a canine handler's arm grasping the end loop of the canine lead of FIG. 4 connected to the canine collar of FIG. 1;

FIG. 7 is a perspective view of a canine handler's arm grasping an intermediate hand loop of the canine lead of FIG. 4 connected to the canine collar of FIG. 1; and

FIG. 8 is a perspective view of a canine handler's arm grasping the end hand loop of the canine lead of FIG. 4 connected to the canine collar of FIG. 1.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

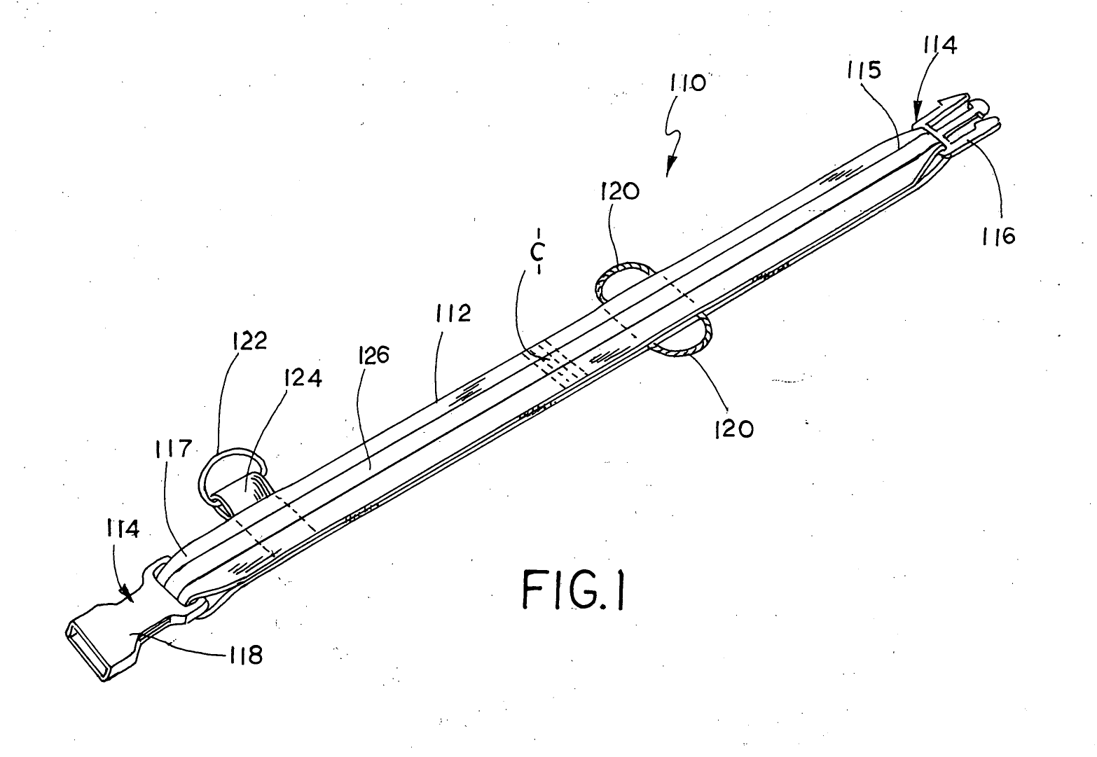

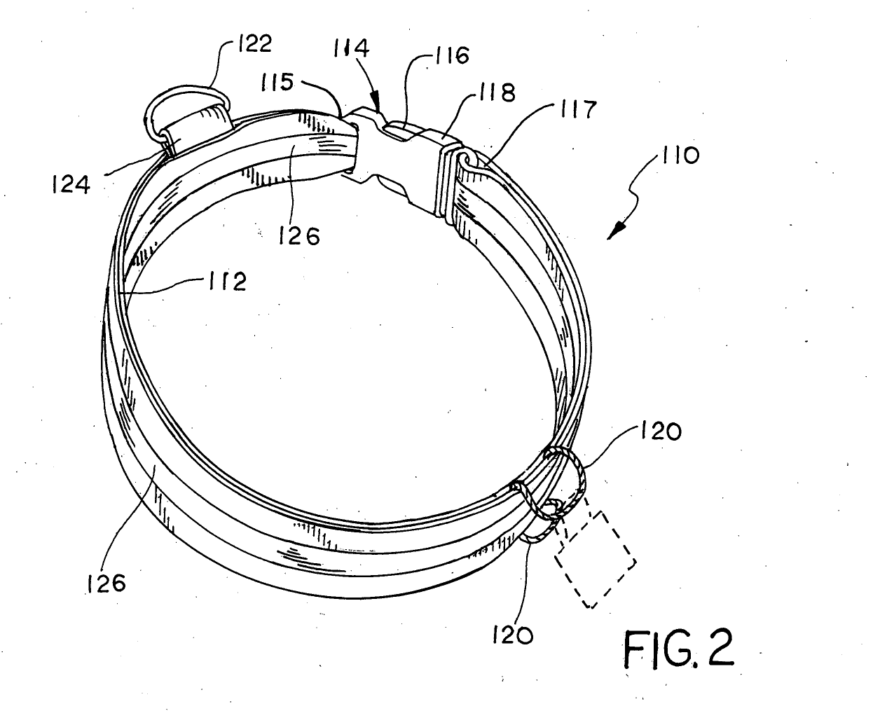

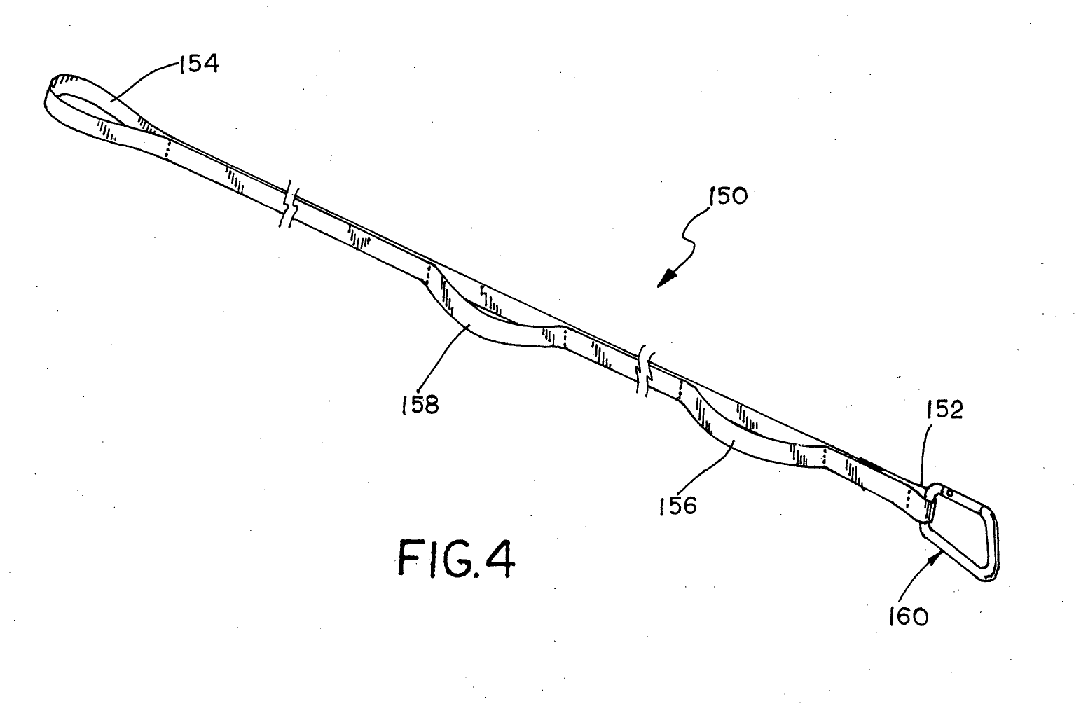

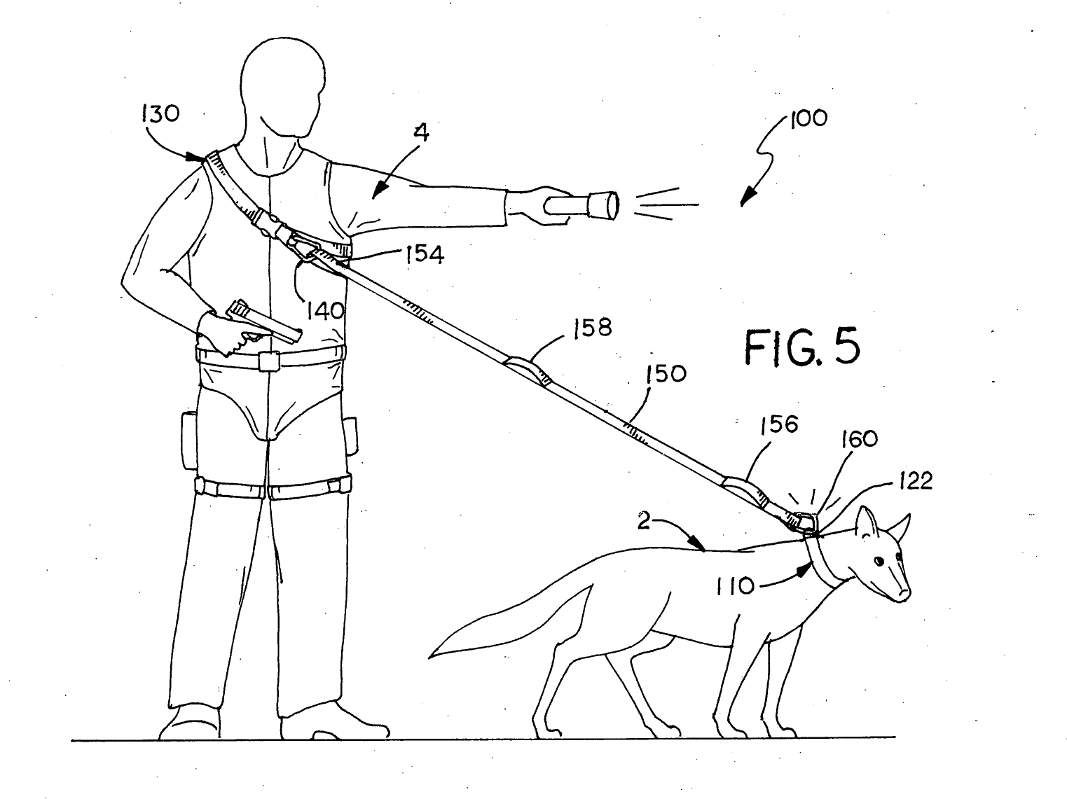

Referring now to the drawings, FIGS. 1-4 illustrate an embodiment of the canine handling apparatus of this invention, which is designated generally as reference numeral 100. The handling apparatus consists in combination of a collar 110 (FIGS. 1 and 2), shoulder sling 130 (FIG. 4), and lead 150 (FIG. 5) which are detachably coupled by a pair of carabiners 140 and 160. Each component of the handling apparatus is primarily constructed from lengths of nylon webbing, but may be constructed from other suitable material, such as leather. The nylon webbing is sewn or otherwise connected using conventional methods and technique well known in the arts. Various buckles, slides, adjusters and rings may be employed as desired within the teaching of this invention.

As shown in FIGS. 1 and 2, collar 110 is constructed from a length of nylon strap 112 whose ends are connected by a conventional quick connect buckle 114. Strap 112 is doubled over and sewn flat with its ends joined at the center C of the collar and forming two looped ends 115 and 117. Looped end 115 and 117 extend through male buckle part 116 and female buckle part 118. Collar 110 has a longitudinal reflective strip 126 sewn to both sides of strap 112. Two opposed Tag loops 120* of braid cord or cable extend from the side of collar 110. Tag loops 120 are located between center point C of collar 110 and end loop 117. A D-ring 122 is connected to collar 110 by a strap loop 124 that extends from one side of collar 110. It should be noted that D-ring 122 and tag loops 120 are oriented along the length of collar strap 112 to be 180 degrees directly opposite one another when buckle 114 is connected.

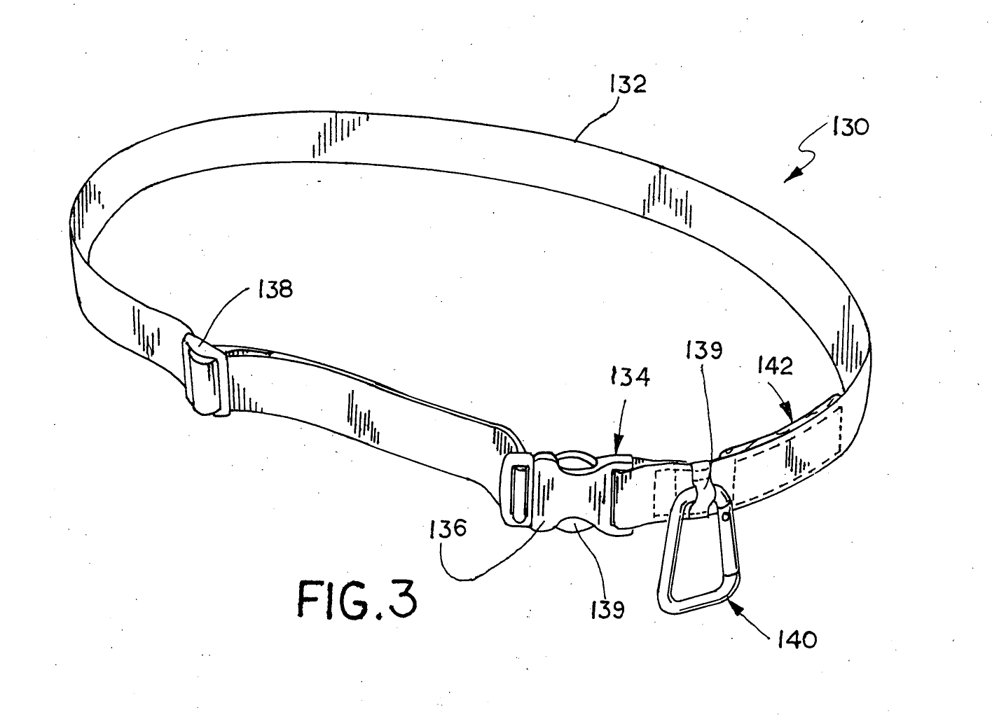

As shown in FIG. 3, shoulder sling 130 is constructed of a length of nylon strap 132 with ends connected by conventional quick connect buckles 134 having male and female parts 135 and 136. The length of sling 130 is adjustable using adjustment slides 138 to accommodate handlers of different sizes. A carbiner 140 is secured to shoulder sling 130 by a piece of webbing 139 sewn to the strap 132. A pouch 142 is sewn to the inside of sling 130 to stow small carry items, such as fecal collection bags, a dog whistle or key. Pouch 142 consists of a small length of strap webbing or other material sewn to the back of strap 132.

As shown in FIG. 4, lead 150 is constructed of another length of nylon strap doubled over and sewn flat to form looped ends 152 and 154 and two additional hand loops 156 and 158. Hand loop 156 is approximately centered between end loops 152 and 154. Hand loop 158 is located adjacent (distal) end loop 152. As shown, (distal) end loop 152 is smaller than (proximal) end loop 154. End loop 154 is dimensioned to receive a handler's hand and wrist, while end loop 152 is dimensioned to receive carabiner 160, which is used to connected to D-ring 122 of collar 110.

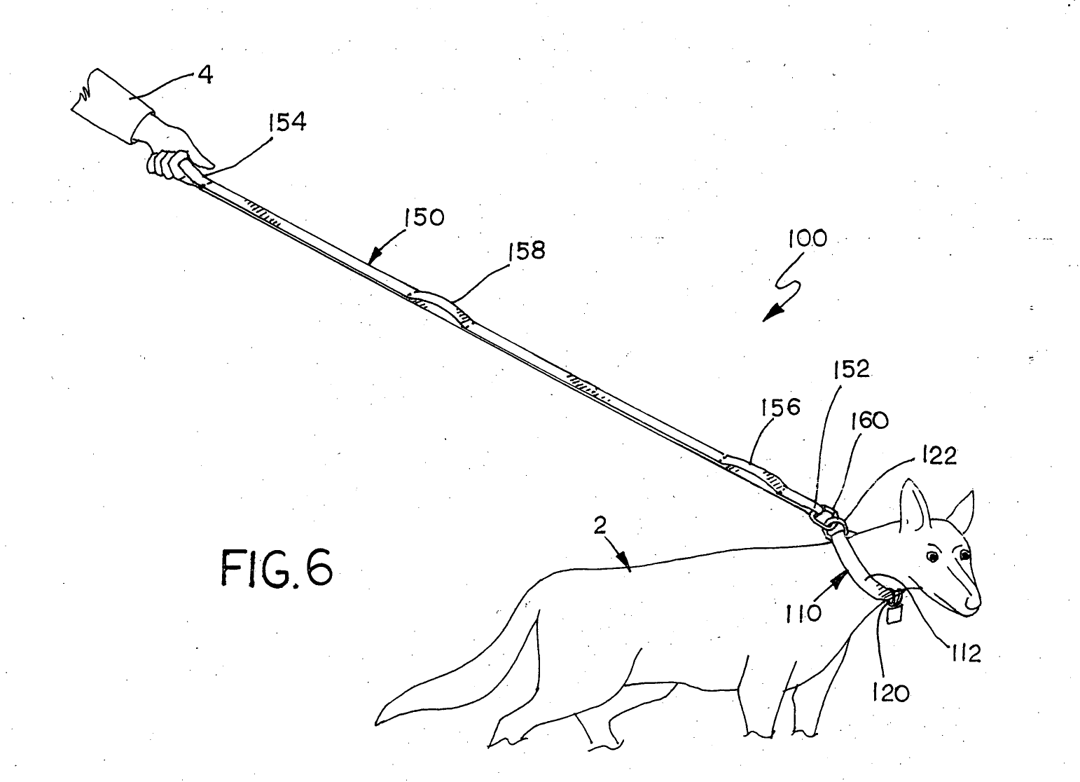

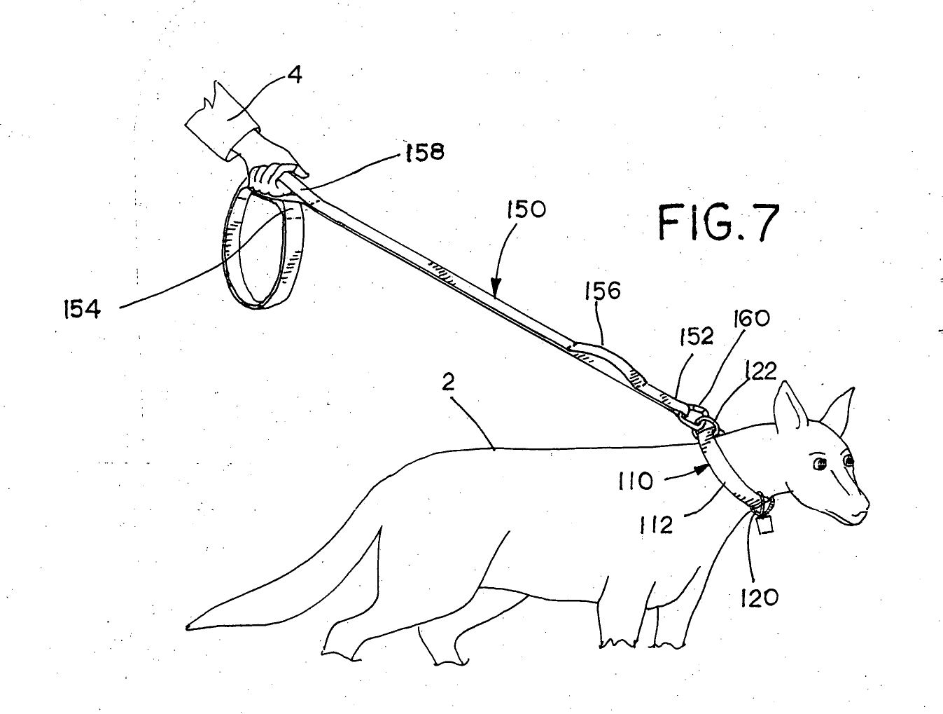

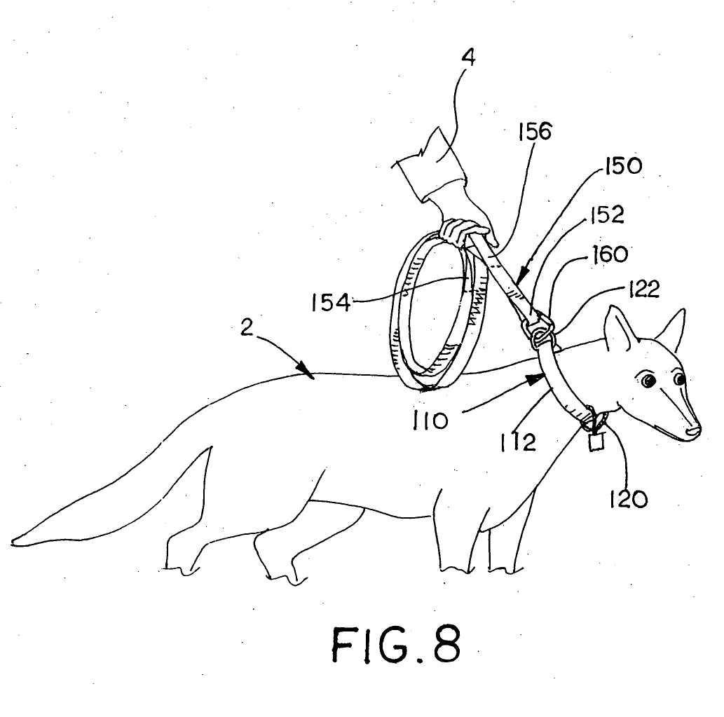

FIGS. 5-8 illustrate how collar 110, sling 130 and lead 150 are used in handling a dog. As shown, collar 110 is worn by dog 2 and sling 130 is worn by handler 4. Typically, sling 130 is worn around the torso over one shoulder (FIG. 5), but may be worn around the waist as a belt if desired. It should be noted that quick connect buckles 114 and 134 of collar 110 and sling 130 respectively assist in donning and doffing. In FIG. 5, carabiners 140 and 160 connect lead 150 to collar 110 and sling 130 so that dog 2 is tethered directly to handler 4, without the handler having to grip lead 150. As shown, carabiner 140 affixed to sling 130 couples end loop 154 of lead 150 and carabiner 160 affixed to lead 150 couples D-ring 122 of collar 110. With lead 150 coupled to both sling 130 worn by handler 4 and collar 110 worn by dog 2, the handler retains free use of both hand while maintaining positive control of the dog. In FIGS. 6-8, collar 110 and lead 150 are used without sling 130. As shown, lead 150 has three looped hand holds position formed by end loop 154 and hand loops 156 and 158, which allows handler 4 to handle dog 2 at different distances and levels of control. Grasping lead 150 at the end loop 154 positions dog 2 furthest from handler 4 allowing the dog more freedom of movement but less handler control (FIG. 6). Grasping lead 150 using both hand loop 158 and end loop 154 positions dog 2 at an intermediate distance from handler 4 lessening the dogs freedom of movement and increased handler control (FIG. 7). Grasping lead 150 using all three hand loops 154, 156 and 158 positions the handler's hand close to collar 110 giving the handler the positive control over dog 2 (FIG. 8).

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1: A dog collar comprising:
an elongated collar strap having opposed ends;
a buckle part for detachably connecting the opposed ends of the collar strap;
a ring part connected to the collar strap between opposed ends; and
a tag loop affixed to the collar strap between the opposed ends so that the ring part and tag loop are oppositely spaced 180 degrees from one another when the buckle part connects the opposed ends of the collar strap.

2: A canine handling apparatus comprising:
a collar; a sling; and a lead,
the collar includes an elongated collar strap having opposed ends, a buckle part for detachably connecting the opposed ends of the collar strap, a ring part connected to the collar strap between opposed ends, and a tag loop affixed to the collar strap between the opposed ends so that the ring part and tag loop are oppositely spaced 180 degree from one another when the buckle part connects the opposed ends of the collar strap.

3: The apparatus of claim 2 wherein the sling includes an elongated sling strap having opposed ends, a sling buckle part for detachably connecting the opposed ends of the sling strap, and a first carabiner affixed to the sling strap between the opposed ends of the sling strap for detachably connecting the sling to the lead.

4: The apparatus of claim 2 wherein the lead includes an elongated lead strap having opposed ends thereof terminating in a first looped end and a second looped end, and first hand loop formed therein spaced between the first looped end and the second looped end, and a second hand loop formed therein spaced between the first hand loop and first looped end.
